(19) United States
(12) Patent Application Publication
(10) Pub. No.: US 2014/0204629 A1
(43) Pub. Date: Jul. 24, 2014

(54) ACPOWER PUPPLY POWER CIRCUIT

(71) Applicant: CHYNG HONG ELECTRONIC CO., Taichung (TW)

(72) Inventor: Mu-Chun Lin, Taichung (TW)

(73) Assignee: CHYNG HONG ELECTRONIC CO., Taichung (TW)

(21) Appl. No.: 13/744,713

(22) Filed: Jan. 18, 2013

(51) Int. Cl. H02M 5/42

(52) U.S. Cl. CPC H02M 5/42
USPC 363/34

(57) ABSTRACT

An AC power supply power circuit comprises a power input unit connected to a DC/AC converter. The AC/DC converter is connected to a DC/DC circuit, and the DC/DC circuit is further connected to an adjustable DC voltage regulation circuit. The adjustable DC voltage regulation circuit is connected to an amplifier to amplify and convert the DC voltages into the AC voltages, thereby outputting different AC voltages and electric currents under the condition of not switching off the power supply and attaining not to stop outputting when adjusting the voltage via cross position, so that a power level is switched promptly and a distortion thereof is very low.

### BACKGROUND OF THE INVENTION

1. Field of the Invention

The present invention relates to an AC power supply power circuit.

2. Description of the Related Art

Referring to FIG. 1, a block diagram of a conventional AC power supply power circuit is shown. An output procedure generated from a structure of the power circuit is described as follows. A power input unit 1 receives an AC voltage provided from the outside. The power input unit 1 is connected to an AC/DC converter 2 and converts the AC voltage provided from the power input unit 1 into a DC voltage via a filter and rectification.

The DC voltage output from the AC/DC converter 2 is converted by a stable power of a first lateral circuit 3 and sent to a transformer 4 for being transformed. The transformer 4 includes a set of primary winding 5 and two sets of secondary windings 6. The primary winding 5 is electrically connected to the first lateral circuit 3. The DC voltage transformed from the transformer 4 is output via the secondary windings 6. The secondary windings 6 are respectively connected to a second lateral circuit 7 thereby supplying a full-wave rectified DC voltage. The full-wave rectified DC voltage is respectively amplified by two amplifiers 8 connected to the second lateral circuits 7, and converted into a sinusoidal output AC voltage.

The amplifiers 8 are further connected to a contact circuit 9 thereby controlling a contact of the contact circuit 9 to be disconnected from the contacts P1, P2, which allows the amplifiers 8 to be connected in parallel. The contact circuit 9 is able to control the disconnecting sequence and position, so that the contact of the contact circuit 9 is disconnected from the contacts S1, S2, and the amplifiers 8 are connected in series. Therefore, the series and parallel circuits of the output terminal of the amplifier are switched via the contact of the contact circuit 9 so as to adjust different AC voltages output from the AC power supply.

The AC power supply power circuit attains the purpose of supplying different AC voltages by switching the parallel-series output of the output terminal of the amplifiers. Since the AC power supply power circuit outputs different AC voltages via a plurality of parallel-series connections of the amplifiers, a complicated circuit and an increasing cost are caused. Moreover, the operation of the contact circuit belongs to a parallel-series switch with contacts but not to a stepless adjusting output mode, so the contact disconnecting sequence of contacts of the contact circuit has to be controlled when switching and outputting different AC voltages for avoiding a short circuit. In this manner, the voltage output needs to be interrupted, which renders the transmitted power level unable to be switched promptly.

Referring to FIG. 2, another conventional AC power supply power circuit which substantially has a similar structure to the previous AC power supply power circuit is shown. The improved power circuit is characterized in that the contact circuit 9 is connected to the second lateral circuit 7, and only one amplifier 8 is connected to the contact circuit 9 in this AC power supply power circuit.

An output procedure of the AC power supply power circuit is described as follows. The power input unit 1 receives the AC voltage supplied from the outside. An AC/DC converter 2 converts the AC voltage processed by a filter and rectification into a DC voltage. The DC voltage is output from a first lateral circuit 3 to a transformer 4 for being transformed and becomes a full-wave rectified DC voltage via the second lateral circuits 7. Different DC voltages are output by the contact circuit 9 which switches the parallel-series connection of the second lateral circuits 7 and transmitted to the amplifier 8 for being amplified and converted into a sinusoidal output AC voltage. In other words, the AC power supply power circuit makes use of the contact circuit 9 switching the parallel-series connection of the power terminal of the amplifier 8 for outputting different AC voltages.

The above AC power supply power circuit may simplify the circuit thereof and omit the arrangement of the amplifier. However, since the switching operation of the parallel circuit and the series circuit of the contact circuit relies on the contacts but not on a stepless adjusting output mode, the contact circuit must be switched when the power supply is shut off to change the parallel and series connections of the power terminal of the amplifier for the voltage adjustment when the AC power supply switches and outputs different AC voltages. Therefore, the conventional design causes the inconvenient operation of the AC power supply and needs an improvement.

Referring to FIG. 3, a schematic view of the outputting power level of the conventional AC power supply in switching is shown. The AC power supply power circuit supplies a low-voltage power by the parallel input of the power terminal of the amplifier. The AC power supply power circuit supplies a high-voltage power by the series input of the power terminal of the amplifier. In low-voltage power supply, the power terminal of the amplifier parallelly inputs the power supply of the low voltage and high electric current. In high-voltage power supply, the power terminal of the amplifier serially inputs the power supply of the high voltage and low electric current. The power level is unable to be switched promptly in switching, that is to say, the voltage stops outputting in switching. Therefore, it may cause a great distorted error while stopping outputting. Hence, the AC power supply power circuit is restricted and has the above-mentioned disadvantages.

In terms of that, the inventor of the present invention holds the spirit of trying for the best with the experiences of devoting to the professional development, manufacture, and marketing of the electronic equipments and the related components, thereby improving the disadvantages of the conventional AC power supply power circuit.

### SUMMARY OF THE INVENTION

It is an object of the present invention to provide an AC power supply power circuit, which supplies different AC voltages and electric currents and constantly outputting the voltages when adjusting the voltages via cross position, so that the power level is able to be switched promptly and a distortion thereof is very low.

The present invention in accordance with the AC power supply power circuit comprises a power input unit supplying an AC voltage from the outside. The power input unit is connected to an AC/DC converter and transforms the AC voltage input therefrom into a DC voltage via a filter and rectification. The AC/DC converter is connected to a DC/DC circuit. The DC/DC circuit includes a first lateral circuit connected to a transformer. The transformer is connected to a second lateral circuit for transforming a voltage level and becoming a full-wave rectified DC voltage. The second lateral circuit is connected to an adjustable DC voltage regulation circuit for regulating and stabilizing a voltage level of the DC voltage output from the second lateral circuit. The adjustable DC voltage regulation circuit is connected to an amplifier for amplifying and converting the DC voltage output from the adjustable DC voltage regulation circuit into the AC voltage.

The AC power supply power circuit is connected to the adjustable DC voltage regulation circuit via the DC/DC circuit, and further connected to the amplifier so as to simplify the circuit and lower the cost, thereby outputting different AC voltages under the condition of not stopping the power supply and attaining the purpose of not constantly outputting when adjusting the voltage via cross position. Therefore, the power level is able to be switched promptly and a distortion is very low.

### BRIEF DESCRIPTION OF THE DRAWINGS

FIG. 1 is a block diagram showing a conventional AC power supply power circuit;

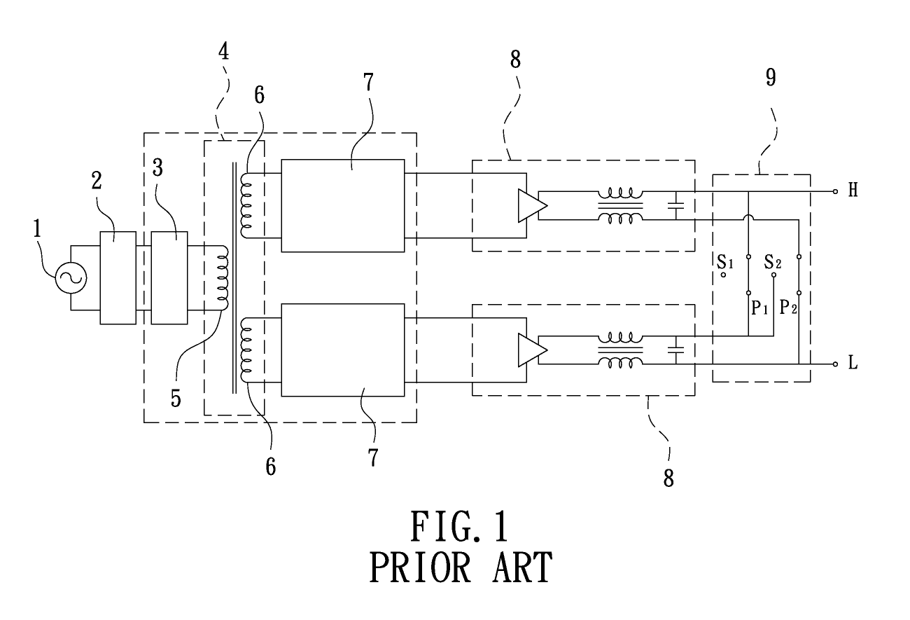

FIG. 2 is a block diagram showing the conventional AC power supply power circuit;

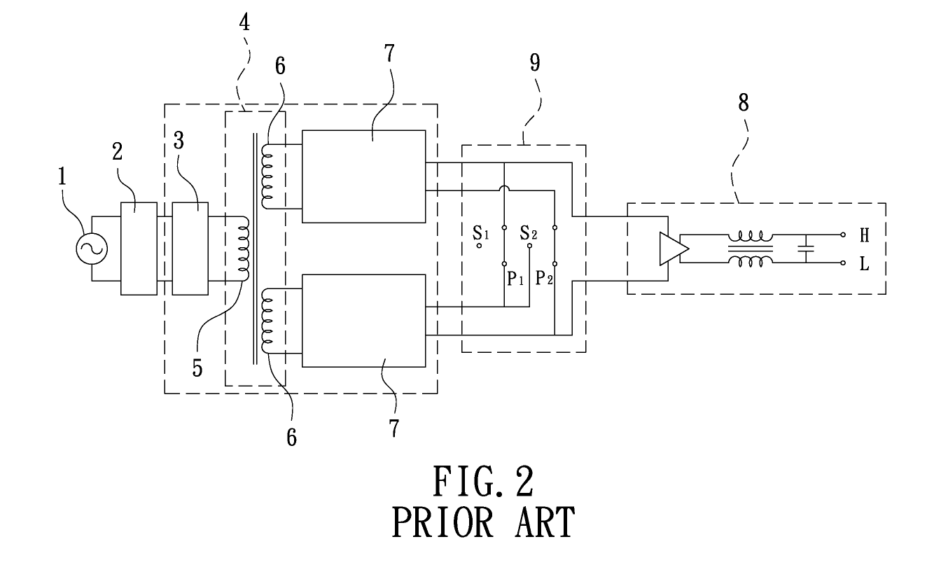

FIG. 3 is a schematic view showing a power level output from the conventional AC power supply power circuit in switching;

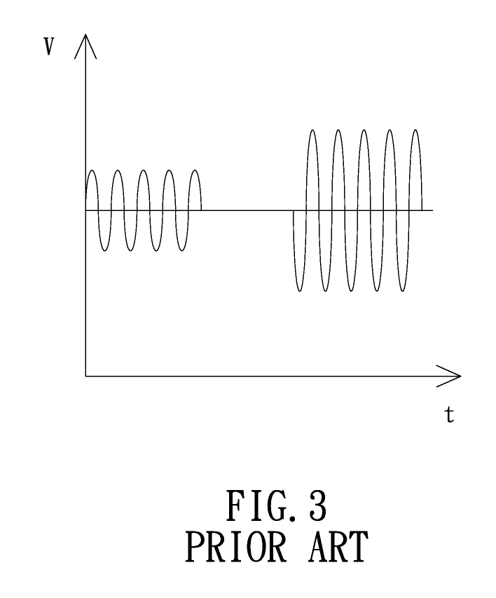

FIG. 4 is a block diagram showing a preferred embodiment of the present invention; and

FIG. 5 is a schematic view showing the power level output from the preferred embodiment of the present invention in switching.

### DETAILED DESCRIPTION OF THE PREFERRED EMBODIMENTS

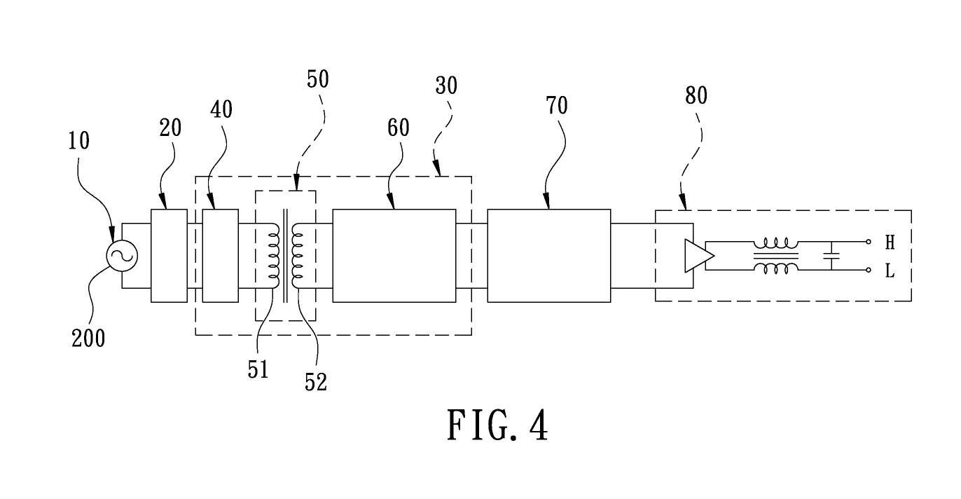

Referring to FIG. 4 showing a block diagram of a preferred embodiment of the present invention comprising:

A power input unit 10 externally connected to an AC power 200, thereby supplying an AC voltage from an outside.

An AC/DC converter 20 connected to the power input unit 10 for receiving the AC voltage supplied from the power input unit 10 and converting the AC voltage input from the power input unit 10 into a DC voltage via a filter and rectification.

A DC/DC circuit 30 connected to the AC/DC converter 20. The DC/DC circuit 30 includes a first lateral circuit 40. The first lateral circuit 40 is connected to the AC/DC converter 20 and is able to execute a conversion of a stable power of the DC voltage converted by the AC/DC converter 20. The first lateral circuit 40 is connected to a transformer 50. The transformer 50 includes a set of primary winding 51 and a set of secondary winding 52. The primary winding 51 is connected to the first lateral circuit 40 and receives the DC voltage output from the first lateral circuit 40 for transforming the voltage level of the DC voltage. The DC voltage transformed by the transformer 50 is output from the secondary winding 52. The secondary winding 52 is connected to a second lateral circuit 60 for providing a full-wave rectified DC voltage formed by rectifying and filtering the DC voltage which is transformed by the transformer 50 and output via the secondary winding 52.

An adjustable DC voltage regulation circuit 70 defined as an adjustable DC/DC circuit. In this preferred embodiment, the adjustable DC voltage regulation circuit 70 is preferably adopted by a step-down converter but not limited to the embodiment scopes of the present invention. The adjustable DC voltage regulation circuit 70 is connected to the second lateral circuit 60 of the DC/DC circuit 30 for regulating and stabilizing a voltage level of the DC voltage output from the DC/DC circuit 30. Furthermore, the adjustable DC voltage regulation circuit 70 regulates the DC voltage output from the DC/DC 30 into a different voltage level, thereby adjusting to output DC voltages of different voltage levels.

An amplifier 80 connected to the adjustable DC voltage regulation circuit 70, thereby amplifying and transforming the DC voltage output from the adjustable DC voltage regulation circuit 70 into the AC voltage.

Referring to FIG. 4, when the power input unit 10 receives the AC voltage supplied externally, the AC voltage is processed via the filter and rectification and converted into the DC voltage via the AC/DC converter 20, a stable power of which is converted by the first lateral circuit 40, output to the primary winding 51, and then transformed via the transformer 50. The transformed DC voltage is further output by the secondary winding 52, and the second lateral circuit 60 provides a full-wave rectified DC voltage by rectifying and filtering the DC voltage output from the secondary winding 52. Furthermore, the voltage level of the DC voltage output from the second lateral circuit 60 is stepless-regulated and stabilized by the adjustable DC voltage regulation circuit 70. Since the adjustable DC voltage regulation circuit 70 is a stepless-adjusting voltage level, the circuit thereof does not need to be switched for the disconnection so as to adjust different outputs of the DC voltages under the condition of not switching off the power supply. The voltage level of the DC voltage is adjusted to be correspond to the DC voltage of the AC voltage that is about to be output from the AC power supply of the present invention. The DC voltage is transmitted to the amplifier 80 for being amplified and converted into the corresponding AC voltage output. In this manner, the AC power supply power circuit of the present invention takes advantages of the adjustable DC voltage regulation circuit 70 which can adjust different outputs of DC voltages under the condition of not switching off the power supply so that the DC voltages are converted into different AC voltages. The AC power supply of the present invention is allowed to output different AC voltages, which attains the purpose of adjusting the voltages via cross position without interrupting the output, switching the power level promptly, and reaching a very low distortion thereof.

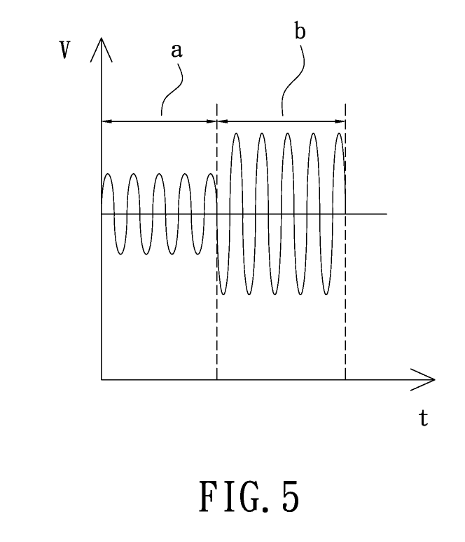

Referring to FIG. 5, a schematic view of the power level output from the preferred embodiment of the present invention in switching is shown. When the AC power supply power circuit is in a low-voltage power supply, an AC supply with a low voltage and high electric current a is provided. The AC voltage output from the amplifier is a low-voltage less than 150 volts and is in a low-voltage power supply position through the adjustable DC voltage regulation circuit, thereby supplying a DC voltage corresponding to the AC voltage converted and output from the amplifier. When the AC power supply power circuit is in a high-voltage power supply, an AC supply with a high voltage and low electric current b is provided. The AC voltage output from the amplifier is a high-voltage over 150 volts and is in a high-voltage power supply position through the adjustable DC voltage regulation circuit, thereby supplying a DC voltage corresponding to the AC voltage converted and output from the amplifier. Since the circuit does not need to be switched for the disconnection, the different DC voltage outputs are able to be adjusted under the condition of not switching off the power supply, so that the power level output from the AC power supply power circuit of the present invention can be switched continuously and promptly.

Another state of the adjustable DC voltage regulation circuit of the present invention is a dynamic regulation according to which proceeds an instant supply voltage regulation of the adjustable DC regulation circuit in light of an efficiency of converting the DC voltage output from the adjustable DC voltage into an AC voltage according to different voltage levels of the AC voltage output from the amplifier. A schematic view of the power level output from this practice in switching is shown as FIG. 5. The different DC voltage outputs may be adjusted under the condition of not switching off the power supply, so that the power level output from the AC power supply is able to be switched continuously and promptly.

The AC power supply power circuit of the present invention makes use of the DC/DC circuit to be connected to the adjustable DC voltage regulation circuit and the amplifier. Therefore, comparing with the conventional AC power supply power circuit, the AC power supply power circuit of the present invention omits a DC/DC circuit and an amplifier for simplifying the circuit and decreasing the cost.

I claim:

1. An AC power supply power circuit comprising:
a power input unit externally connected to an AC power, thereby supplying an AC voltage from an outside;
an AC/DC converter connected to said power input unit for converting said AC voltage input from said power input unit into a DC voltage via a filter and rectification;
an DC/DC circuit connected to said AC/DC converter for providing a full-wave rectified DC voltage which is formed by transforming a voltage level of said DC voltage output from said AC/DC converter;
an adjustable DC voltage regulation circuit connected to said DC/DC circuit for regulating and stabilizing said voltage level of said DC voltage output from said DC/DC circuit; and
an amplifier connected to said adjustable DC voltage regulation circuit for amplifying and converting said DC voltage output from said adjustable DC voltage regulation circuit into an AC voltage.

2. The AC power supply power circuit as claimed in claim 1, wherein said DC/DC circuit includes a first lateral circuit connected to a transformer; said transformer is further connected to a second lateral circuit.

3. The AC power supply power circuit as claimed in claim 2, wherein said first lateral circuit is connected to said AC/DC converter.

4. The AC power supply power circuit as claimed in claim 2, wherein said transformer includes a set of primary winding and a set of secondary winding; said primary winding is connected to said first lateral circuit, and a DC voltage transformed by said transformer is output via said secondary winding.

5. The AC power supply power circuit as claimed in claim 4, wherein said second lateral circuit is connected to said secondary winding for providing a full-wave rectified DC voltage formed by rectifying and filtering said DC voltage which is transformed by said transformer and output via said secondary winding.

6. The AC power supply power circuit as claimed in claim 1, wherein said adjustable DC voltage regulation circuit is a constant voltage regulation; when said AC voltage output from said amplifier is a high-voltage over 150 volts, said adjustable DC voltage regulation circuit is in a position of high-voltage power supply; when said AC voltage output from said amplifier is a low-voltage less than 150 volts, said adjustable DC voltage regulation circuit is in a position of low-voltage power supply.

7. The AC power supply power circuit as claimed in claim 1, wherein said adjustable DC voltage regulation circuit is a dynamic regulation according to which proceeds an instant supply voltage regulation of said adjustable DC regulation circuit in light of an efficiency of converting said DC voltage output from said adjustable DC voltage into an AC voltage according to different voltage levels of said AC voltage output from said amplifier.

8. The AC power supply power circuit as claimed in claim 1, wherein said adjustable DC voltage regulation circuit is a step-down converter.
